(19) United States
(12) Patent Application Publication
(10) Pub. No.: US 2003/0143995 A1
(43) Pub. Date: Jul. 31, 2003

(54) Virtual channel satellite communication system with improved bandwidth efficiency

(76) Inventors: Robert F. Friedman, Fayetteville, AR (US); John Bush, Sunol, CA (US); Greg Garner, Springdale, AR (US); John C. Thacker, Los Altos, CA (US)

Correspondence Address: GARY CARY WARE & FREIDENRICH LLP, 1755 EMBARCADERO ROAD, PALO ALTO, CA, 94303-3340, US

(21) Appl. No.: 10/316,591

(22) Filed: Dec. 10, 2002

Related U.S. Application Data
(63) Continuation-in-part of application No. 10/039,632, filed on Oct. 26, 2001.
(63) Continuation of application No. 09/438,865, filed on Nov. 12, 1999, now Pat. No. 6,452,989.
(60) Provisional application No. 60/339,711, filed on Dec. 11, 2001.

(51) Int. Cl. H04Q 7/20; H04B 7/185

(52) U.S. Cl. 455/429; 455/427; 455/12.1

(57) ABSTRACT

Presented is a satellite communication system that allows aggregation of available transponder bandwidth. A channel signal is divided into subparts (e.g., data packets), formatted (e.g., encapsulated) and distributed among a plurality of subchannels according to bandwidth availability. Each subpart is encoded with information that facilitates proper reconstruction of the original channel data at the receiving station. The subchannels are transmitted to a receiving station, which synchronizes the subchannels and decapsulates the subparts. The receiving station includes a subchannel combiner which combines the decapsulated subparts in select subchannels to produce a reconstructed version of a user-selected channel signal. A controller in the receiving station identifies the subchannels to be combined in response to user selection and sends commands to a subchannel combiner. The receiving station also includes a connectivity matrix that discards the unnecessary subchannels before demodulation and reconstruction, reducing the number of demodulators in the system.

### RELATED APPLICATIONS

This application claims priority from U.S. Provisional Application No. 60/339,711 filed on Dec. 11, 2001 and entitled “Virtual Satellite Applications to Fixed Satellite Service,” which is incorporated herein by reference in its entirety. This application is a continuation-in-part application of U.S. patent application Ser. No. 10/039,632 filed on Oct. 26, 2001, which is a continuation application of U.S. application Ser. No. 09/438,865 filed on Nov. 12, 1999 and which is incorporated herein by reference in its entirety.

### BACKGROUND

This invention relates generally to satellite communications systems, and particularly to satellite communication systems that divide and recombine the transmitted signal.

The satellite communications industry has experienced significant performance enhancements in the last few decades. Some examples of these performance enhancements include an increase in transmission power capability of satellite transponders, improvements in low-noise amplifier (LNA) characteristics, and a decrease in the size of receiving antennas. In satellite systems with a large number of receiving stations, it is particularly important to reduce the cost of each receiving unit and to design a system with a small receiving antenna to meet installation and aesthetic requirements. The need for a small receiving antenna has motivated an increase in transponder power output in order to maintain an acceptable signal-to-noise ratio (SNR) with the smaller antenna. As a result of these performance enhancements that boosted the popularity of small receiving antenna-high power transponder combination, the cost of low power transponders dropped significantly. However, many satellite users cannot take advantage of this economically efficient option because the bandwidth necessary to provide full featured programming is distributed among multiple low power transponding satellites operated by multiple satellite operators.

Attempts to overcome this problem include channel splitting, which includes splitting the original signal into subchannel signals, transmitting the subchannel signals through satellite transponders, and later recombining the subchannel signals so that the end user receives a reconstructed version of the original signal. Channel splitting, however, does not solve the problem of only a limited bandwidth being available for each subchannel. The limited bandwidth necessitates acquiring extra satellite capacity to transmit all the data, and the cost of developing extra satellite capacity might cancel out any cost saving associated with using a low power transponder. In order to make the use of the low power transponder an economically practical option, a way of using low power transponders and small receiving antennas without developing extra satellite capacity is needed.

### SUMMARY

The invention is a method and system for cost-effectively using low power transponders and small receiving antennas in a satellite communications system. The invention reduces the need to develop extra satellite capacity by efficiently aggregating the available subchannel bandwidth(s). The system includes an uplink system and at least one receiving station that may be used in combination or independently. The uplink system receives at least one channel signal, divides the channel signal into a plurality of subparts (e.g., data frames), and distributes the subparts among one or more subchannels depending on the bandwidth that is available. Preferably, the channel splitter system encodes, in the header of each subpart, information necessary for proper reconstruction. The subchannels are transmitted to the receiving station, which combines the subparts of the subchannels into the proper channel signal for end users.

As the subchannels arrive at the receiving station via a plurality of propagation paths, the delay experienced by each subchannel is different. Thus, the receiving station synchronizes the subchannels and combines the synchronized subchannels to reconstruct a delayed version of the signal for the channel a user selected.

### DESCRIPTION OF THE DRAWINGS

FIG. 1 is a schematic and block diagram illustrating the satellite communication system in accordance with the invention;

FIG. 2 depicts the uplink system of FIG. 1;

FIG. 3 depicts the uplink system of FIG. 1 in a multi-channel embodiment.

FIG. 4 depicts the channel splitter of FIG. 2;

FIG. 5 depicts the receiving station of FIG. 1 including a connectivity matrix;

FIG. 6 depicts the receiving station of FIG. 1;

FIG. 7 depicts the subchannel combiner of the receiving station in FIG. 1;

FIG. 8 depicts a process that data packets go through for the channel splitting and subchannel combining processes;

FIG. 9 depicts the channel fragmentation and encapsulation process that takes place in the uplink system; and

FIG. 10 depicts the channel defragmentation and decapsulation process that takes place in the receiving station.

### DESCRIPTION OF THE INVENTION

The invention is particularly directed to a satellite communication system wherein data is transmitted from an uplink station to a receiving station via satellite transponders, and will be described in that context. It will be appreciated, however, that this particular use is illustrative as only one utility of the invention.

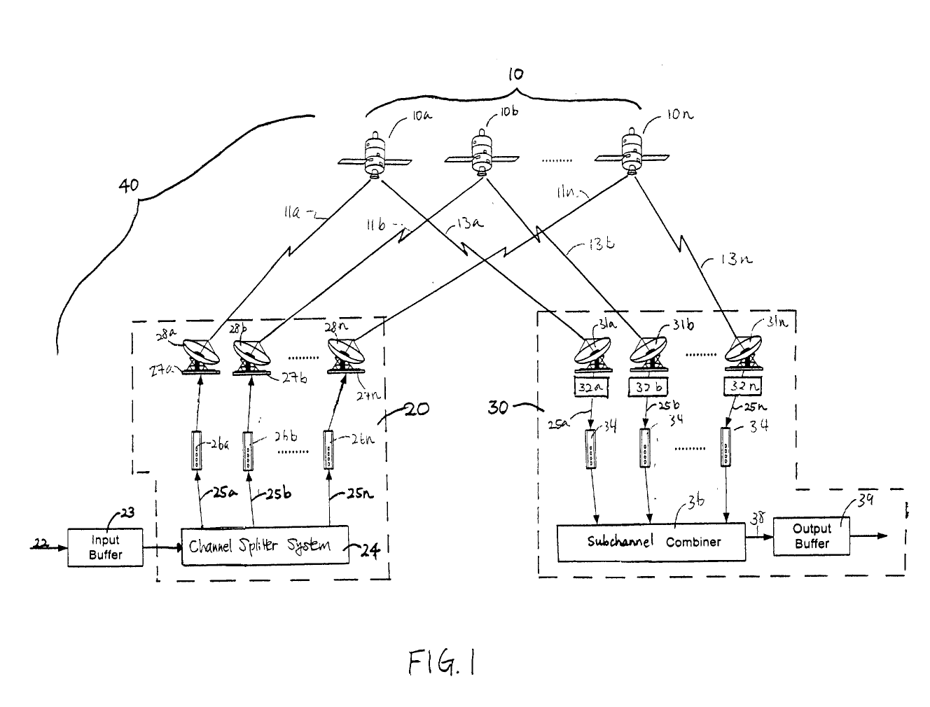

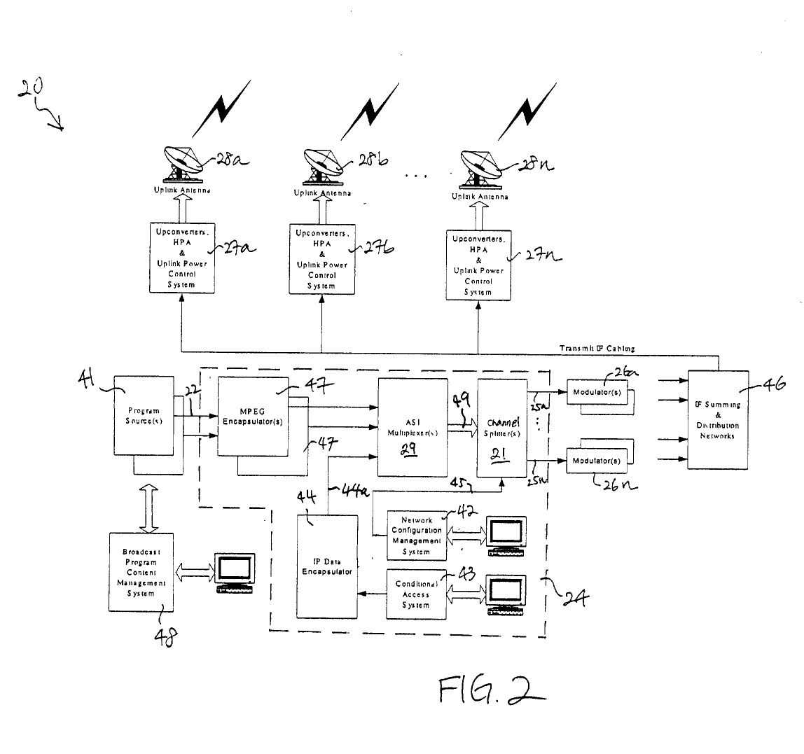

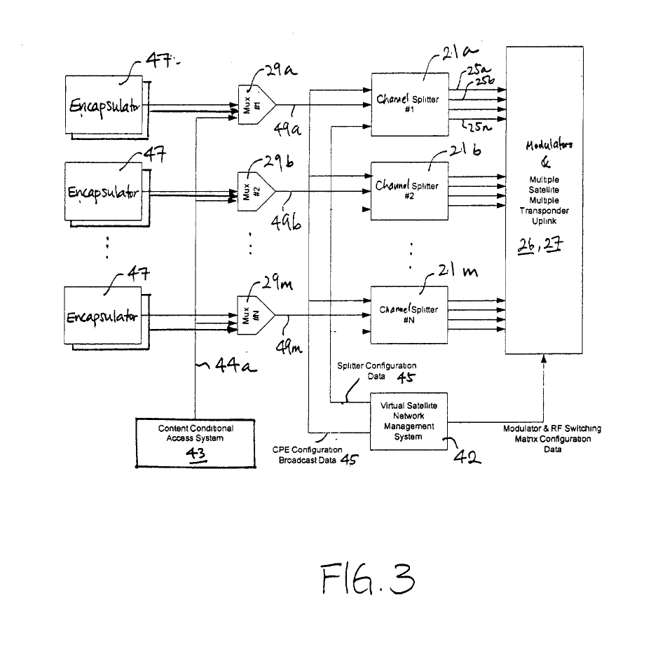

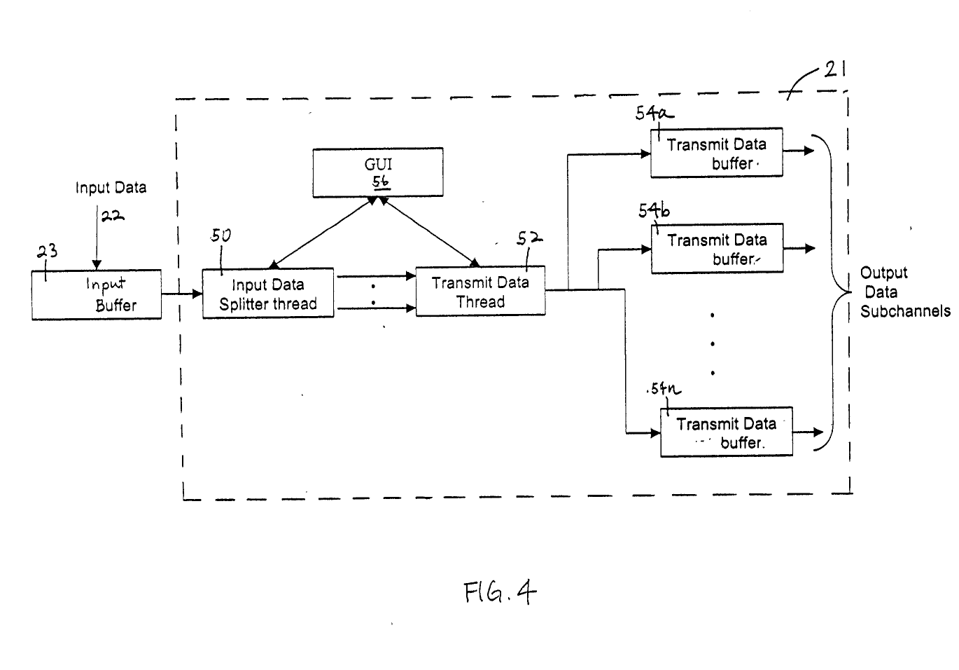

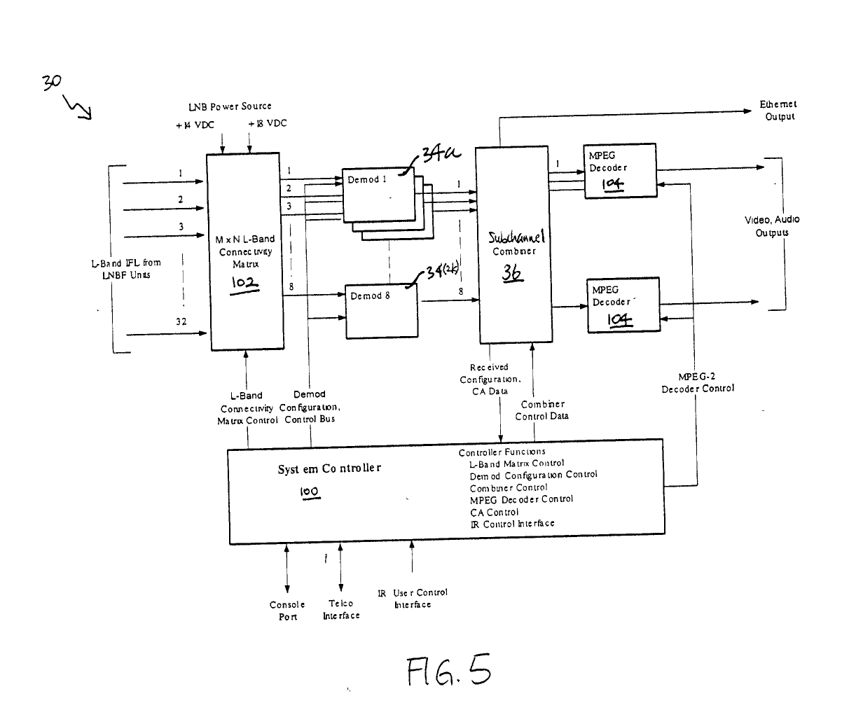

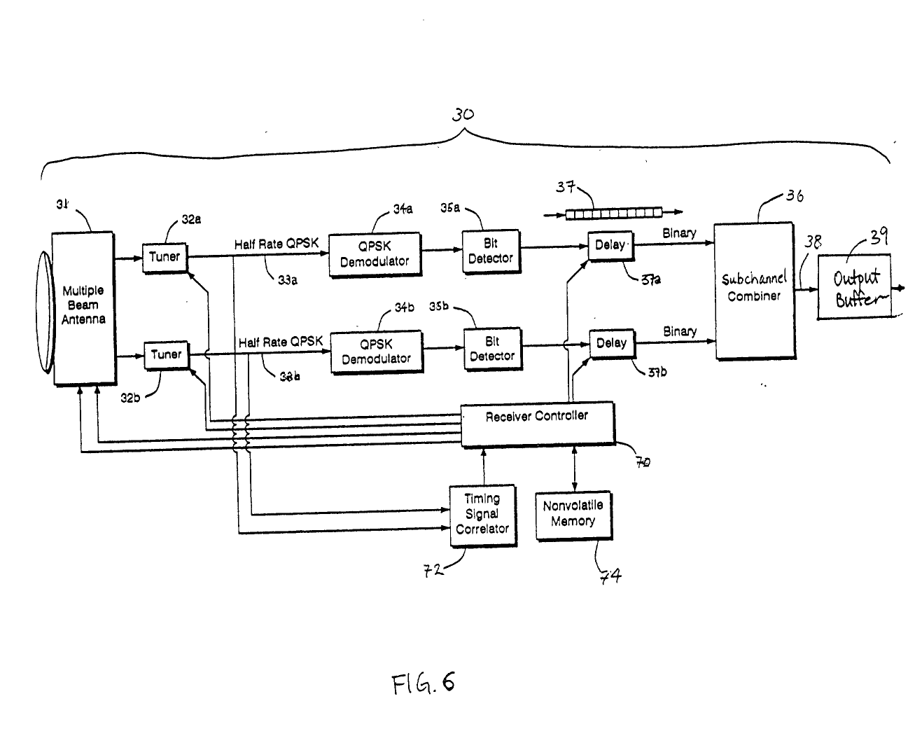

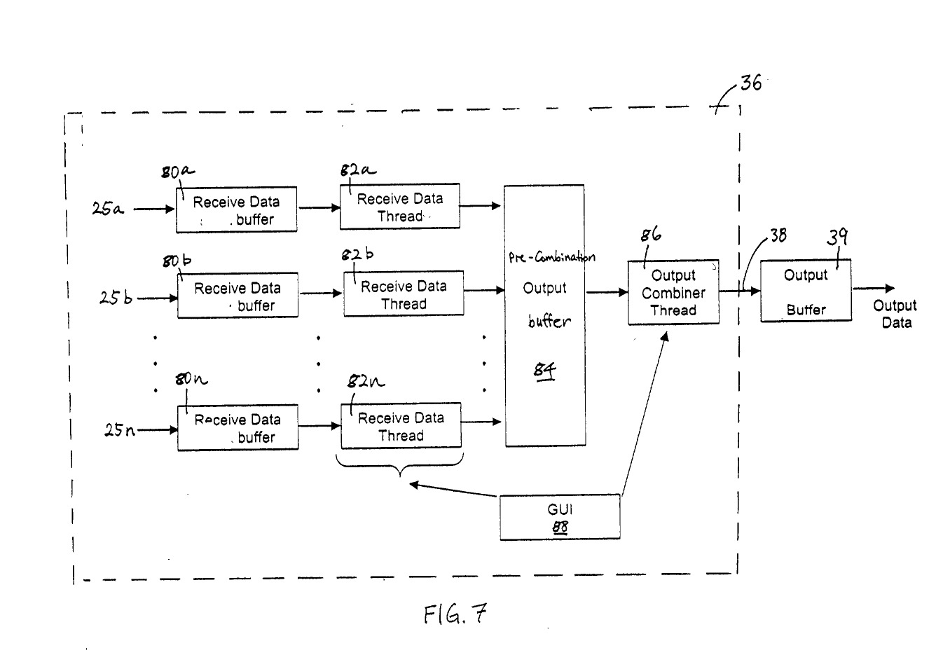

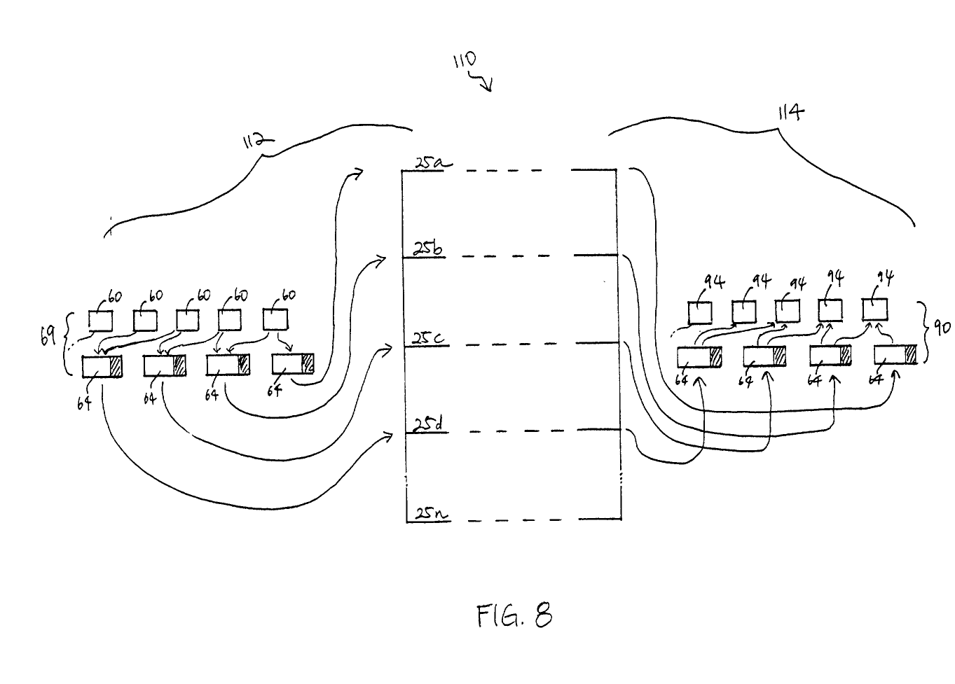

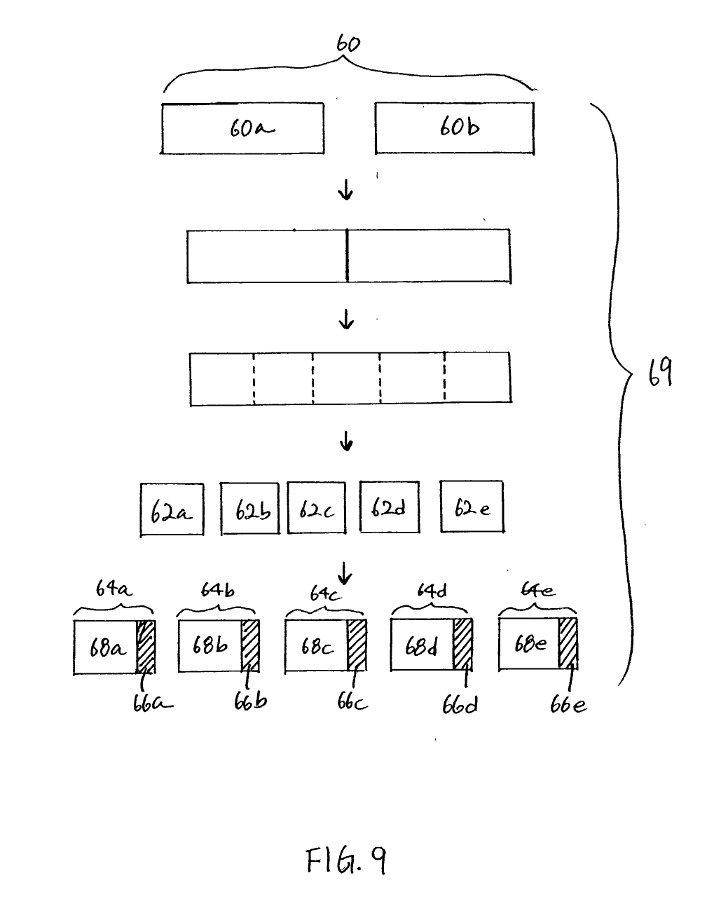

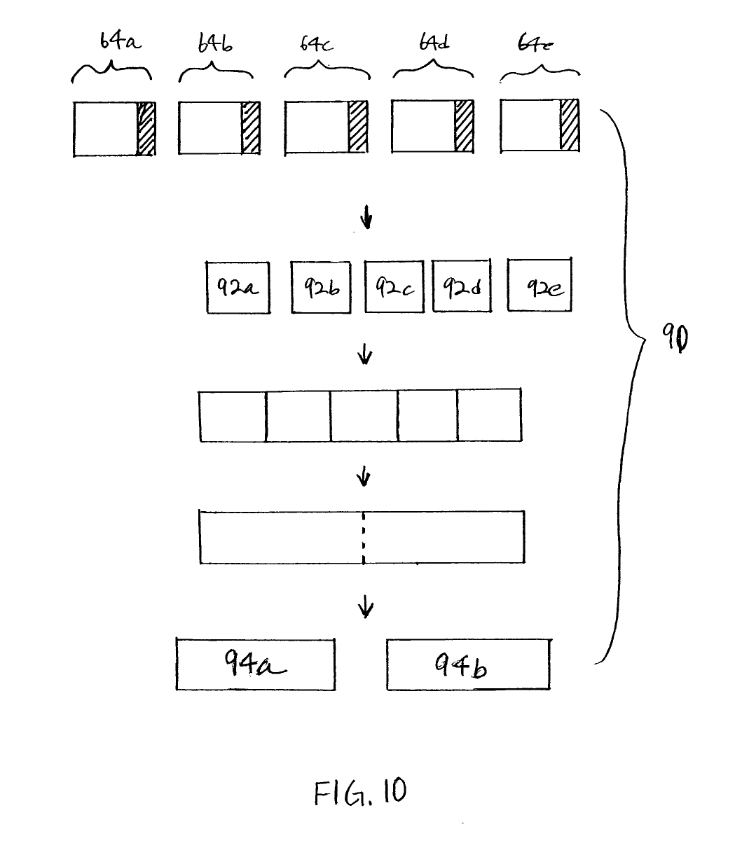

FIG. 1 provides an overview of the satellite communication system including the invention. FIG. 2, FIG. 3, and FIG. 4 depict portions of the system that are close to the source of the data to be uplinked and transmitted. FIG. 5, FIG. 6, and FIG. 7 depict portions of the system that are close to the end user equipment that receives the transmitted data. FIG. 8, FIG. 9, and FIG. 10 depict the processes to which data are subjected while being transmitted according to the invention. The invention allows users to take advantage of the small receiving antenna-low power transponder combination by providing a means for aggregating available bandwidth(s) to provide sufficient virtual capacity that can support full featured programming.

FIG. 1 shows a first embodiment of the satellite communication system 40 consisting of transponders 10, uplink system 20, and receiving station 30. Uplink system 20 includes an input buffer 23, a channel splitter system 24, one or more modulators 26a-26n, one or more uplink stations 27, and one or more transmission antennas 28. Although FIG. 1 shows uplink stations 27 as uplink stations 27a-27n and the transmission antennas 28 as antennas 28a-28n for clarity of illustration, the invention is not limited to there being the same number of uplink stations and antennas as modulators. The transponders 10 may be a plurality of satellite transponders. Receiving station 30 includes one or more receiving antennas 31, one or more tuners 32, one or more demodulators 34, a subchannel combiner 36, and an output buffer 39. Again, although FIG. 1 shows receiving antennas 31 as receiving antennas 31a-31n and tuners 32 as tuners 32a-32n for clarity of illustration, the invention is not limited to these particular number of components.

A channel signal 22 is fed into the input buffer 23, which controls the rate of data being provided to the channel splitter system 24. The output from the input buffer 23 is then fed into the channel splitter system 24 at a data rate of R and bandwidth of B. The channel splitter system 24 divides the channel signal 22 into n subchannels 25a-25n, wherein “n” is the number of transponders 10 available. Subchannels 25a-25n may all have the same bandwidth or have different bandwidths. Each subchannel signal travels at a data rate that is a fraction of the channel data rate R and a bandwidth that is a fraction of the channel bandwidth B such that the sum of the data rates of all the subchannel signals is approximately R and the sum of the bandwidths of all the subchannel signals is approximately B. Each of subchannels 25a-25n feed into modulators 26a-26n, respectively, and the modulated signals are fed into uplink transmitters 27a-27n and transmission antennas 28a-28n. The transmission antennas 28a-28n transmit each of the signals in subchannels 25a-25n to one of the orbiting satellite transponders 10a-10n as shown by uplink propagation paths 11a-11n.

A “subchannel”, as used herein, is a communication path that carries at least part of the content of the channel signal 22 at a fraction of the channel signal data rate R and the channel signal bandwidth B. When the content of the channel signal 22 is divided among a plurality of subchannels, the data stream of channel signal 22 is divided into “subparts” such as data packets, and assigned to a subchannel. A “subpart”, therefore, is a piece of the content of the channel signal 22 that is transmitted over a subchannel. More details on how the channel signal 22 is divided is provided below.

Each satellite transponder 10a-10n receives a transmission in a band of frequencies from transmission antenna 28a-28n, amplifies the signals received in that frequency band, and retransmits the signals at a different frequency band to receiving antennas 31a-31n. Each of the satellite transponders 10a-10n has an antenna that directs the received subchannel signal to receiving station 30. It should be understood that although FIG. 1 depicts each uplink signal as being carried by a different satellite, the invention is not so limited. For example, two or more transponders, such as transponders 10a and 10b, could be located on one satellite. In this case, uplink transmitters 27a and 27b could be combined into a single uplink transmitter, which would result in the combining of uplink antenna systems 28a and 28b into a single uplink antenna, the combining of propagation paths 11a and 11b into a single uplink propagation path, and the combining of propagation paths 13a and 13b into a single downlink propagation path.

As shown by downlink propagation paths 13a-13n, receiving antennas 31a-31n of receiving station 30 receive the retransmitted signals. The received subchannels 25a-25n are fed into tuners 32a-32n, demodulators 34a-34n, and eventually into the subchannel combiner 36. The subchannel combiner 36 combines subchannels 25a-25n to produce reconstructed signal 38, which is substantially similar to the channel signal 22. The reconstructed signal 38 passes through output buffer 39, which holds the signal until they are ready to be transmitted to the end user. Although the exemplary embodiment of FIG. 1 shows the number of subchannels to be three, the invention is not so limited since it may use one or more subchannels.

The modulators 26a-26n may be any of the commercially available Digital Video Broadcasting (DVB) modulators. Each of modulators 26a-26n converts the input signal into a frequency wave having the frequency of a selected satellite transponder. Uplink transmitter 27a-27n, transmission antenna 28a-28n, receiving antennas 31a-31n and tuners 32a-32n that are suitable for satellite communication system 40 are well known in the art. Modulators 26a-26n and demodulators 34a-34n match the rates of all subchannels so that the subchannels can be recombined properly into reconstructed signal 38 having data rate R. A person of ordinary skill in the art will understand that DVB modulation is not a required part of the invention but rather a part of the invention that is included to enhance cost efficiency.

The receiving antenna 31a-31n in may be implemented with a plurality of single beam antenna components, a single multiple beam antenna, or a combination of single beam and multiple beam antennas to receive the plurality of satellite signals traveling along propagation paths 13a-13n. Receiving antenna 31a-31n produce a plurality of output signals corresponding to satellite signals that were received via propagation paths 13a-13n. This signal identity remains true whether satellites 10a and 10b are distinct or represent the same satellite as indicated in the foregoing description.

The output of receiving antenna 31a-31n feed a plurality of tuners 32a-32n, which then drive a plurality of demodulators 34a-34n. The tuners 32a-32n translate the frequency of each received subchannel signal to a fixed intermediate frequency of equal bandwidth. In one embodiment, the tuners 32a-32n emit quaternary phase shift keying (QPSK) modulated signals at a frequency that demodulators 34a-34n expect to receive. The demodulators 34a-34n may be any of the commercially available DVB demodulators a person of ordinary skill in the art would consider to be suitable for data rate matching. Each signal emerging from demodulators 34a-34n represents a modified version of the corresponding subchannel signals 25a-25n.

FIG. 2 depicts the uplink system 20 in more detail. The channel signal 22 originates from one or more program source(s) 41. The content of the program source(s) 41 is determined by a broadcast program content management system 48, which may be a content broadcasting station (e.g., Fox). The channel signal 22, which include raw data packets, feeds into the channel splitter system 24 and become encapsulated in one or more MPEG encapsulator(s) 47, which fragment and encapsulate the raw data packets as described below in reference to FIG. 8 and FIG. 9. The “overlapping” layers of program source 41 and MPEG encapsulator 47 in FIG. 2 indicate that a stream of data packets are encapsulated for each program or each channel. The streams of encapsulated data packets are multiplexed in one or more multiplexer(s) 29 along with information 44a from a conditional access system 43. The conditional access system 43 keeps track of which channels each of the receiving stations (e.g., set top boxes) is allowed to receive. If, for example, a particular receiving station is allowed to receive ESPN but not HBO (e.g., because the user of the receiving station paid for a package that does not include HBO), the conditional access system 43 includes an encryption key for ESPN but not for HBO in the information 44a for the particular receiving station. An IP data encapsulator 44 formats the information 44a before it is fed into the multiplexer 29. The multiplexer 29 multiplexes the information 44a and a plurality of channels/programs that it receives to create a multiplexed virtual channel 49. The channel splitter 21 then receives this virtual channel 49 and splits it into subchannels 25a through 25n. One or more channel splitter(s) 21 receives network configuration data 45 from a network configuration management system 42, which maintains configuration data about which subchannels carry data for a particular program/channel. The network configuration data 45, therefore, contains a “channel map” that matches each program/channel to one or more subchannels. Once each of these subchannels 25a through 25n are modulated by modulators 26a through 26n, respectively, a distribution network 46 forwards the subchannels to proper upconverter and uplink power control system 27a-27n and to the uplink antennas 28a-28n.

FIG. 3 shows an embodiment of the channel splitter system 24 including a plurality (m) of multiplexers 29a-29m. Since each encapsulator 47 encapsulates one program/channel, this multiple-multiplexer embodiment includes a plurality of encapsulators 47 feeding encapsulated data streams into each of the m multiplexers. As mentioned above in reference to FIG. 2, the multiplexers 29a-29m receive information 44a regarding conditional access from the content conditional access system 43. Each of the multiplexers may receive identical information 44a. The multiplexers 29a-29m generate virtual channels 49a-49m, each of which feeds into one of the channel splitters 21a-21m. Also fed into the channel splitters 21a-21m are the configuration broadcast data 45 from the network management system 42. The network management system 42 determines the splitter and CPE configuration broadcast data 45 by using the content channel configuration and the space segment subchannel configuration. The content channel configuration specifies the output of the content multiplexers 29 and their bandwidths. The outputs of a content multiplexers 29, which are DVB transport streams, are mapped one-to-one to virtual transponders and each transport stream has a bandwidth of around 36 MHz. As for the splitter and CPE broadcast configuration data 45, this data specifies the satellites, the transponders on each of the satellites, and the frequencies and bandwidths of each subchannel on each transponder. The total combined bandwidths of the subchannels is sufficient to handle all of the content. The channel splitters 21a-21m divide up each of the virtual transponders into subchannels and sends each subchannel to a separate modulator 26 (see FIG. 2).

The operating cost of the satellite communication system 40 increases with the number of subchannels n. The network management system 42 minimizes the total cost of the space segment needed for satellite communication by assigning each DVB transport stream coming out of the content multiplexers 29 to one or more subchannels (each subchannel can only be associated with one DVB transport stream). By assigning the content to the subchannels, the network management system 42 has effectively constructed a mapping of the content channels to subchannels. The configuration broadcast data 45 includes this mapping information. The network management system 42 also sends individual channel/subchannel configuration to each channel splitter 21 based upon the overall system channel/subchannel configuration, and to the modulators 26 and an RF switching matrix (not shown) in the uplink transmitters 27. This channel/subchannel map is sent to the receiving station 30 so that the receiving station 30 can determine which set of subchannels to combine in order to reconstruct a content stream. The end user sees the content channels as displayed in a program guide. The end user does not see the physical subchannel mapping.

FIG. 4 depicts an exemplary channel splitter 21, which receives the outcome of input buffer 23. The input buffer 23 holds the channel signal 22 until the channel splitter 21 is ready to receive the channel signal 22. The channel splitter 21 is a computer with software modules such as an input data splitter thread 50, a transmit data thread 52, and transmit data buffers 54a-54n. The input signal that comes out of input buffer 23 enter input data splitter thread 50, which divides the incoming stream of data frames among a preselected number (n) of subchannels. The channel splitter 21 is programmed with the configuration of subchannels 25a-25n, such as the number of subchannels and the available bandwidth of each subchannel. Using this configuration information, channel splitter 21 divides the input signal in a way that uses the available bandwidth of each subchannel while keeping recombination as easy as possible. For example, the data frames may be distributed on a sequential frame-by-frame basis to the available bandwidth in each successive subchannel. Typically, in a content-division process, the content of the channel signal 22 is divided such that the signals in each of the subchannels contain at least some mutually exclusive information. The subchannel signals coming out of the input data splitter thread 50 feed into the transmit data thread 52, which prepares each subchannel signal to be transmitted through separate subchannels 25a-25n. The transmit data thread 52 properly directs the data frames into one of transmit data buffers 54a-54n, each of which connects to subchannels 25a-25n, respectively. At the appropriate time, data frames leave transmit data buffer 64a-64n and feed into modulators 26a-26n (see FIG. 1). The channel splitter system 21 may be configured manually by a user using a Graphic User Interface 56 to configure the data splitter thread 50 and the transmit data thread 52. In alternative configurations, the configuration data may be transmitted automatically from the virtual satellite system's network management system 42.

FIG. 5 depicts a system controller 100 that is a part of the receiving station 30 that may reside in an end user equipment, e.g., a set top box. Although not shown, a person of ordinary skill in the art would understand that the antennas 31a through 31n (see FIG. 1) that precede a connectivity matrix 102 may have n (e.g., 16) Low Noise Block Converter Feed (LNBF) devices that receive signals from different satellites. The connectivity matrix 102 connects the n dual-polarization LNBF devices mounted on the antennas to at least k demodulators, wherein “k” is the predetermined maximum number of subchannels that are combined to form the one or more selected virtual transponders 49 which contain real channel programs. As the n dual-polarization LNBF devices result in 2n L-band coaxial inputs of uniform polarization states, a total of 2n (e.g., 32 in the example shown) different subchannel signals can be received. In the particular example, 32 subchannel signals are fed into the connectivity matrix 102. While the connectivity matrix 102 receives all 32 subchannel signals, it discards the subchannel signals that are not needed to reconstruct the user-selected channels and outputs only the necessary subchannel signals. In the example of FIG. 5, k=4 (i.e., four subchannels are combined to reconstruct a channel signal). However, the connectivity matrix 102 shown in the example generates 2k (i.e., 8) subchannels because the particular end user equipment is made to support at least two output devices (e.g., televisions). Thus, the particular system can send two different channels to two different output devices.

The system controller 100 receives a program selection from a user and uses the channel map from the network configuration data 45 to determine which eight subchannels of subchannels 25a-25n are needed to produce the two selected channels. The system controller 100 then forwards the identity of these eight subchannels to the connectivity matrix 102 so that the connectivity matrix 102 can discard the unnecessary subchannels and output the eight subchannels needed to produce the selected channels. The 2k outputs that were fed into demodulators 34a through 34(2k) become combined into channels in subchannel combiner 36. The recombined programs/channels coming out of the subchannel combiner 36 are what is herein referred to as “virtual channels”, similar to the virtual channels 49 that were fed into the channel splitter(s) in FIG. 2 and FIG. 3. The channels are then decoded in an MPEG decoder 104. The system controller 100, which is part of the end user equipment, sends commands (e.g., electrical signals) to the connectivity matrix 102, the demodulators 34, and the combiner 36 to ensure that the subchannels are properly combined. The system controller 100 also controls the decoders 104 and exchanges information with a user through a user control interface (e.g., infrared control interface). The content of the combined channel is then presented in a video and/or audio output to an end user. The components of the end user equipment shown in FIG. 5 are commercially available, and a person of ordinary skill in the art would understand how to build this end user equipment based on the information provided herein.

The connectivity matrix 102 reduces the number of coaxial cables between the outdoor unit and the end user equipment. It also reduces the cost of the indoor unit by using fewer demodulators than the total number of subchannels, since the unnecessary subchannels are discarded before reaching the demodulators. The input and output may use standard L-band coaxial cable, which may also be used to supply DC power to the LNBFs. Each output is capable of being connected to any of the 2n inputs. An output can be connected to no more than one input, and an input can be connected to more than one output.

FIG. 6 depicts an exemplary two-subchannel (n=2) receiving station 30 in accordance with one embodiment of satellite communication system 40. In this embodiment, the radio frequency carriers feeding the demodulators 34a and 34b are quaternary phase shift keying (QPSK) modulated signals and receiving antenna 31 is a multiple beam antenna, although the invention is not so limited. The receiving antenna 31 emits first and second signals into tuners 32a and 32b. Each tuner shifts a band of higher frequencies to a band of lower frequencies of equal bandwidth such that receiver controller 70 sets the center frequency of the higher band, but the lower band is fixed. The tuners 32a and 32b emit QPSK modulated signals 33a and 33b at a frequency that the QPSK demodulators 34a, 34b expect to receive. As there are two subchannels in this embodiment, the data rate of the binary information contained in these QPSK signals 33a, 33b is approximately half the data rate of original channel signal, R. The respective output of QPSK demodulators 34a, 34b emit signals to bit detectors 35a, 35b, which in turn produce streams of binary data corresponding to subchannels 25a, 25b in uplink system 20. The delay operators 37a, 37b synchronize the data streams by introducing delay in the first-arriving binary stream such that there is a minimum of relative delay between the respective delay operator outputs.

The receiver controller 70 responds to user input (not shown) to select the transponders to combine, subsequently emitting control signals to receiving antenna 31 to direct its antenna patterns toward the satellites containing the selected transponders. Receiver controller 70 also selects each tuner frequency consistent with the signals emitted from the selected transponder. Receiver controller 70 further processes information from a timing signal correlator 72 to determine the correct setting of the delay operators 37a, 37b. The timing signal correlator 72 receives and time-correlates tuner outputs 33a, 33b. For a system with more than two subchannels, timing signal correlator 72 processes tuner outputs in pairs to determine the relative delay between subchannels. A nonvolatile memory 74 contains parameters regarding the user-selected transponders to enable the correct setting of receiving antenna 31 and tuners 32a, 32b. In one embodiment, timing signal correlator 72 correlates the output 33a, 33b from tuners 32a, 32b with a stored version of the known timing signal, or by processing the recovered timing signal through a process that will produce a periodic output in response to the timing signal. One example of such a process is a matched filter. Once the delays 37a, 37b are adjusted to remove relative subchannel delay, tuners 32a, 32b are set to conduct the selected information-bearing transponder signals to the respective demodulators.

The subchannel combiner 36 reverses the content division process of subchannel splitter system 24 so as to produce at its output a faithful delayed replica of original channel signal 22. The subchannel combiner 36 combines the outputs of delays 37a, 37b to produce reconstructed signal 38. The reconstructed signal 38 is substantially similar to original channel signal 22, and is transmitted at data rate of R and bandwidth of B. The subchannel combiner 36 forwards reconstructed signal 38 to the output buffer 39. The reconstructed signal 38 is eventually viewed/heard by end users in a variety of commercially available formats, e.g., ASI.

In the case where a plurality of satellites are used to conduct a set of subchannels from an uplink system to a given receiving station, each subchannel will generally experience a different propagation delay. The receiving station 30 provides a method for determining the amount of time delay each subchannel experienced in order to combine them synchronously. Moreover, the receiving station 30 can accommodate the delay spread that may become present when using multiple satellites. For example, for an original channel running at 27 Mbps, the method accommodates more than 10 ms of delay spread. This capacity to accommodate 10 ms of delay should prevent most errors caused by delay spread, as satellites in a visible arc of 30 degrees have a maximum delay spread of approximately 6 ms.

FIG. 7 depicts a subchannel combiner 36 in accordance with a preferred embodiment of satellite communication system 40. The subchannel combiner 36 first receives subchannel signals 25a-25n into receive data buffers 80a-80n, respectively. The subchannel signals emerging from the receive data buffers 80a-80n enter receive data threads 82a-82n, respectively, and wait until the receive data threads 82a-82n are ready to receive data. The receive data threads 82a-82n are software modules that are preferably included in the end user equipment. In each of the receive data buffers 80a-80n, data frames are aligned in an order that facilitates recombination. The receive data threads 82a-82n, which receive data when a pre-combination output buffer 84 is ready to decapsulate and regroup the data frames in the subchannels 25a-25n, forwards the data frames that were waiting in the receive data buffer 80a-80n to the pre-combination output buffer 84 in a predetermined order that they will be recombined in. The pre-combination output buffer 84 converts the data frames into raw data packets and regroups them to produce raw data packets substantially similar to the raw data packets of channel signal 22. The pre-combination output buffer 84 feeds the raw packets into an output combiner thread 86 in the order that they will be recombined. The output combiner thread 86 recombines the data packets into reconstructed signal 38. Optionally, graphic user interface data 58 may be added manually to the receive data thread 42a-42n and the output combiner thread 56 by a user to change some parameters that affect the output to the display device. The reconstructed signals exiting the output combiner thread 86 are temporarily held in the output buffer 39.

FIG. 8 schematically depicts the process 110 by which the data from the program source 41 (see FIG. 2) are split and combined. The process 110 includes a content splitting process 112 that takes place in the channel splitter system 24 (e.g., in the channel splitter 21 (shown in FIG. 2)) and a content combining process 114 that takes place in the subchannel combiner 36 (shown in FIG. 5). The channel splitter system 24 receives a stream of raw data packets 60 which are formatted to a specific standard (e.g., MPEG 2), for example by the MPEG encapsulator 47 (shown in FIG. 2). These raw data packets 60 are subjected to an encapsulation process 69. During the encapsulation process 69, the raw data packets 60 are divided into payloads of a predetermined size for each data packet 64. The formatted data packets 64 include headers (shown as shaded portions), each of which contains data (e.g., a counter) that is helpful for properly recombining the data packets later. The formatted data packets 64 are then divided among respective subchannels 25a through 25n via the transmit data thread 52 as described above in reference to FIG. 4. In the particular example shown in FIG. 8, the data packet 64 that is the first in order is transmitted via subchannel 25a, the next data packet 64 is transmitted via subchannel 25b, the data packet 64 after that is transmitted via subchannel 25c, and the fourth data packet 64 is transmitted via subchannel 25d. The subchannels 25a-25n are received by the receive data buffers 80a-80n (shown in FIG. 7) and properly reordered in the pre-combination output buffer 84 (FIG. 7). The transmitted and reordered data packets 64 are then subjected to a decapsulation and defragmentation process 90 to be converted into reconstructed raw data packets 94. These reconstructed raw data packets 94 are eventually combined in the output combiner thread 86 (FIG. 7) of the subchannel combiner 36.

FIG. 9 schematically depicts the fragmentation and encapsulation process 69 that takes place in channel splitter system 24. The channel signal 22, which is a data stream that feeds into input buffer 23 at a data rate of R and bandwidth of B, may consist of raw data packets 60 having an arbitrary format and size. Upon receiving raw data packets 60, input data splitter thread 50 (see FIG. 4) fragments the content of raw data packets 60 into packets 62 of a predetermined size range. The size limitation on each of packets 62 is a function of the frame format and the frame size to be used. In the example shown, the content of raw data packets 60a and 60b are regrouped into packets 62a-62e. Preferably, the regrouping is done without altering the sequence of data in the content of raw data packets 60a and 60b, so as to facilitate the reconstruction of raw data packets later. During the fragmentation process, the content of one raw data packet may be divided between two packets (e.g., packets 62a and 62b both contain content of raw data packet 60a ), or the content of two raw data packet may be combined into one packet (e.g., packet 62c contains contents from raw data packet 60a and raw data packet 60b). Each of packets 62a-62e are then encapsulated in frames of a predetermined size and format to form data frames 64a-64e.

Each of data frames 64a-64e have a header 66a-66e and a payload 68a-68e where the payload 68a-68e stores the content of packets 62a -62e, respectively, and the header 66a-66e contains timing and sequence information that will help proper reconstruction of channel signal 22 later. A person of ordinary skill in the art will understand that the size of input buffer 23 is a function of the speed at which data enters input buffer 23 relative to the speed at which the rest of uplink station 20 processes the signals. Typically, data enter input buffer 23 at approximately the same rate that they leave input buffer 23.

The frame headers 66a-66e may comply with the well-known MPEG2 header standard. Each of the data frames 64a-64e may be 188-byte Digital Video Broadcasting (DVB) frame having a 4-byte header structure and a 184-byte payload. The 4-byte header may preferably include one synchronization status byte, 3 bits of packet type identifier, and 14 bits of sequence counter, plus other standard bits such as error indicator bit, payload unit start indicator, transport priority, etc. The synchronization status byte can be used for determining the start of each frame, identifying the source of the timing clock, trouble-shooting, and enhancing the reliability upon recombination. The sequence counter can be used to re-order the data packets. The channel splitter system 24 encodes any synchronization status bytes in the input data stream to avoid synchronization loss at the modulators 26a-26n. The transport error indicator bit indicates the presence of at least one uncorrectable bit error in the associated transport stream packet. The payload unit start indicator is a single-bit flag indicating where the payload begins, the transport priority bit indicates the priority of the associated packet relative to other packets of the same packet type identifier, and the 3 bits of packet type identifier indicates the type of data that is stored in the payload. The packet type identifier is used to separate the type of payload data such as DVB Transport, virtual satellite network management and control, etc. With 3 bits, the packet type identifier can handle up to 8 data types. The headers 66a-66e have the synch byte as the first byte, the sequence counter in the last 14 bits thereof, and the packet type bits somewhere in between the synch byte and the sequence counter. The definition and the location of the sequence counter and the packet type bits depend on the embodiment.

FIG. 10 schematically depicts the decapsulation and defragmentation process 90 that occurs in the pre-combination output buffer 84 (see FIG. 7). The pre-combination output buffer 84 arranges data frames 64a-64e in an order that facilitates recombination, decapsulates the data frames to convert them into headerless data packets 92a-92e, then defragments them to create the raw data packets 94 that are substantially similar to the data packets 60 in the channel signal 22. Coming out of pre-combination data buffer 84 are raw data packets 94a and 94b that will be combined to form reconstructed signal 38. Modulators 26a-26n and demodulators 34a-34n (see FIG. 1) mark a data frame as NULL when the header of a data frame indicates that the content of the payload is unavailable or unreliable. When recombining the subchannels, any component of subchannel combiner 36 can be designed to discard the data frames marked as NULL.

While several particular forms and variations thereof have been illustrated and described, it will be apparent that various modifications can be made without departing from the spirit and scope of the invention. Accordingly it is not intended that the invention be limited, except by the appended claims.

What is claimed is:

1. A method of satellite communication that allows efficient use of available bandwidth, the method comprising:
receiving a channel signal;
regrouping data in the channel signal into subparts;
dividing the subparts among subchannels according to available bandwidth in each of the subchannels; and
transmitting the subparts to satellite transponders via the n subchannels.

2. The method of claim 1, wherein regrouping the data in the channel signal comprises:
fragmenting the channel signal into data packets; and
encapsulating each of the data packets, wherein the encapsulating includes adding a header that contains information useful for combining the data packets to reconstruct the channel signal.

3. The method of claim 2, wherein fragmenting the channel signal comprises at least one of combining contents of two of the data packets and dividing a content of one of the data packets.

4. The method of claim 2 further comprising assigning each of the encapsulated data packets to one of the subchannels that has available bandwidth.

5. The method of claim 1, further comprising multiplexing a plurality of channel signals to form a virtual channel before dividing the channel signal into subparts.

6. The method of claim 5 further comprising adding conditional access data during the multiplexing, wherein the conditional access data identifies whether an end user equipment is allowed to access each of the subchannels.

7. The method of claim 5 further comprising separately encapsulating each channel signal before the multiplexing.

8. The method of claim 1 further comprising adding network configuration data upon the dividing, wherein the network configuration data includes a map correlating the channel signal to select subchannels.

9. The method of claim 1 further comprising separately modulating each of the subchannels so that each of the subchannels is in a preselected frequency range.

10. The method of claim 1 further comprising:
receiving the subparts transmitted via the subchannels;
identifying a user selected channel;
categorizing the subchannels into a first category and a second category wherein the first category contains subparts needed to reconstruct the user selected channel and the second category contains subparts to be discarded; and
combining the subparts in the first category to reconstruct the channel signal.

11. The method of claim 10 further comprising:
determining an order in which the subparts are to be combined;
defragmenting the subparts; and
decapsulating the subparts.

12. The method of claim 10 wherein categorizing the subchannels further comprises reading a network configuration map that identifies which subchannels contain subparts for the user selected channel.

13. A method of satellite communication that allows efficient use of available bandwidth, the method comprising:
receiving subparts of a channel signal transmitted via subchannels over satellite transponders;
identifying a user selected channel;
categorizing the subchannels into a first category and a second category wherein the first category contains subparts needed to reconstruct the user selected channel and the second category contains subparts to be discarded; and
combining the subparts in the first category to reconstruct the channel signal.

14. The method of claim 13 further comprising:
determining an order in which the subparts are to be combined;
defragmenting the subparts; and
decapsulating the subparts.

15. The method of claim 14 wherein defragmenting the subparts comprises at least one of combining content from two data frames and dividing content of one data frame.

16. The method of claim 14 wherein decapsulating the subparts comprises taking off a header from each of the data frames.

17. The method of claim 13 wherein there are multiple channel signals further comprising reading a network configuration map that identifies which subchannels contain subparts for the user selected channel.

18. A satellite communications system which provides an enhanced digital communication channel, the satellite communications system comprising:
a multiplexer multiplexing a plurality of channel signals to create a virtual channel;
a channel splitter coupled to the multiplexer, the channel splitter dividing the virtual channel into a plurality of subparts according to available bandwidth of each of the subchannels and distributing the subparts among subchannels; and
a plurality of uplink transmitters, each of the plurality of uplink transmitters coupled to the channel splitter, the uplink transmitters transmitting the subchannels toward respective satellite transponders.

19. The satellite communications system of claim 18 further comprising encapsulators that are coupled to the multiplexer, wherein each of the encapsulators fragments and encapsulates each of the plurality of channel signals.

20. The satellite communications system of claim 18 further comprising a plurality of modulators coupled to the channel splitter, each of the plurality of modulators modulating one of the subchannels.

21. The satellite communications system of claim 18 further comprising a conditional access system coupled to the multiplexer, the conditional access system providing information regarding whether a particular receiving station is allowed to receive a particular channel.

22. The satellite communications system of claim 18 further comprising a network configuration management system coupled to the channel splitter, the network configuration management system providing a map indicating the subchannels that carry content for each channel.

23. The satellite communications system of claim 18 further comprising a network configuration management system coupled to the channel splitter and the at least one receiving antenna and providing a map between the subchannels and a plurality of virtual channels.

24. The satellite communications system of claim 18, wherein each of the subparts is a 188-byte data frame including a 4-byte header.

25. The satellite communications system of claim 18, wherein the subparts are data frames in accordance with one of MPEG 1, MPEG 2, MPEG 3, MPEG 4 and Ethernet standards.

26. The satellite communications system of claim 18, wherein each of the subparts includes a header that is sent over the satellite transponders, the header containing information used for the reconstruction of the virtual channel.

27. The satellite communications system of claim 18, wherein data rates for the subchannels are such that a sum of the data rates of the subchannels is approximately equal to the data rate of the channel signal.

28. The satellite communications system of claim 18, wherein bandwidths for the subchannels are such that a sum of the bandwidths of the subchannels is approximately equal to the bandwidth of the channel signal.

29. The satellite communications system of claim 18, wherein at least some of the subchannels travel at different data rates and bandwidths.

30. The satellite communications system of claim 18, wherein the channel splitter comprises:
an input data splitter thread for dividing the channel signal into the subchannels;
a transmit data thread coupled to the input data splitter for directing the subparts into one of transmit data buffers; and
a plurality of transmit data buffers coupled to the transmit data thread, each of the transmit data buffers holding subparts to be transmitted to one of the respective satellite transponders.

31. The satellite communications system of claim 18 further comprising a graphic user interface coupled to the input data splitter thread and the transmit data thread.

32. The satellite communications system of claim 18 further comprising:
at least one receiving antenna collecting signals from the respective satellite transponders; and
a subchannel combiner coupled to the at least one receiving antenna, the subchannel combiner combining select ones of the subchannels into a reconstruction of the virtual channel.

33. The satellite communications system of claim 32 further comprising decapsulators coupled to the subchannel combiner, wherein each of the decapsulators defragments and decapsulates received subparts.

34. The satellite communications system of claim 32 further comprising a controller coupled to the subchannel combiner, the controller identifying the select subchannels to be combined to reconstruct a user-selected channel and sending corresponding commands to the subchannel combiner.

35. The satellite communications system of claim 32 further comprising a decoder coupled to the subchannel combiner to decode the virtual channel and extract actual program content.

36. The system of claim 32, wherein the receiving station further comprises:
a plurality of tuners coupled to the at least one receiving antenna and adjusting the frequency of each of the received subchannels;
a plurality of demodulators, each demodulator coupled to a corresponding tuner output for demodulating the corresponding tuner output and creating a bit stream corresponding to the content of a respective subchannel; and
a plurality of delay means coupled to the plurality of demodulators and delaying the subchannels so that the subchannels are synchronized for proper reconstruction.

37. The satellite communications system of claim 36 further comprising a plurality of modulators coupled to the channel splitter, wherein the plurality of modulators and the plurality of demodulators mark a frame as NULL when the content of the frame is unavailable, and the subchannel combiner discards a frame marked as NULL.

38. The system of claim 32 further comprising:
a nonvolatile memory for storing information about the frequency and propagation delay properties of the subchannels; and
an output buffer coupled to the subchannel combiner.

39. The satellite communications system,of claim 32 further comprising a connectivity matrix for discarding subchannels that are not needed to reconstruct the selected channel.

40. The satellite communications system of claim 32, wherein the channel splitter transmits information concerning the number and the data rates of the subchannels to the subchannel combiner, the information being encoded in a header for each of the subparts.

41. The satellite communications system of claim 32, wherein the subchannel combiner comprises:
a plurality of receive data buffers for receiving subchannel signals from the plurality of demodulators, wherein the subchannel signals include formatted subparts;
a plurality of receive data threads coupled to the plurality of receive data buffers for putting the formatted subparts in an order that facilitates recombination;
a pre-combination output data buffer coupled to the plurality of receive data threads for converting the framed subparts into raw data packets substantially similar to the raw data packets of the channel signal; and
an output combiner thread coupled to the output data buffer for combining the raw data packets into a reconstructed channel signal.

42. A satellite communications system which provides an enhanced digital communication channel, the satellite communications system comprising:
at least one receiving antenna collecting channel signals from n satellite transponders, wherein the channel signals are received as subparts divided among n subchannels; and
a subchannel combiner coupled to the at least one receiving antenna, the subchannel combiner combining select ones of the n subchannels into a reconstruction of the virtual channel.

43. The satellite communications system of claim 42 further comprising a controller coupled to the subchannel combiner, the controller identifying the select subchannels to be combined to reconstruct a user-selected channel and sending commands to the subchannel combiner.

44. The system of claim 42, wherein the receiving station further comprises:
a plurality of tuners coupled to the at least one receiving antenna and adjusting the frequency of each of the received subchannels;
a plurality of demodulators, each demodulator coupled to a corresponding tuner output for demodulating the corresponding tuner output and creating a bit stream corresponding to the content of a respective subchannel; and
a plurality of delay means coupled to the plurality of demodulators and delaying the subchannels so that the subchannels are synchronized for proper reconstruction.

45. The system of claim 42 further comprising:
a nonvolatile memory for storing information about the frequency and propagation delay properties of the subchannels; and
an output buffer coupled to the subchannel combiner.

46. The satellite communications system of claim 42 further comprising a connectivity matrix for discarding subchannels that are not needed to reconstruct the selected channel.

47. The satellite communications system of claim 42 further comprising a connectivity matrix connecting n low noise block converter feed devices on the at least one receiving antenna to at least k demodulators, wherein 2n>k and k is the number of subchannels that are combined to reconstruct a channel signal.

48. The satellite communications system of claim 42 further comprising a connectivity matrix connecting n low noise block converter feed devices on the at least one receiving antenna to at least 2k demodulators, wherein k is the number of subchannels that are combined to reconstruct a channel signal, allowing at least two different channels to be output to a plurality of end user devices.
